(19) United States
(12) Patent Application Publication
(10) Pub. No.: US 2016/0085077 A1
(43) Pub. Date: Mar. 24, 2016

(54) Mount Arm for a Helmet Mounted Display

(71) Applicant: GENTEX CORPORATION, Carbondale, PA (US)

(72) Inventors: Eduard Milea, Irvine, CA (US); David Rogers, Boston, MA (US); Desmond Walsh, Duxbury, MA (US)

(73) Assignee: Gentex Corporation, Carbondale, PA (US)

(21) Appl. No.: 14/891,369

(22) PCT Filed: May 16, 2014
(86) PCT No.: PCT/US14/38355

§ 371 Date: Nov. 16, 2015

Related U.S. Application Data
(60) Provisional application No. 61/824,908, filed on May 17, 2013.

(51) Int. Cl. G02B 27/01

(52) U.S. Cl. CPC G02B 27/0176; G02B 2027/0159; G02B 2027/0156; G02B 2027/0169

(57) ABSTRACT

A mount arm has a first end and a second end where the first end is configured to be mounted to a helmet. The mount arm has a first adjustment mechanism proximate the first end and is configured to position the second end of the mount arm relative to a user's eye when the mount arm is mounted to the helmet. A second adjustment mechanism is proximate the second end of the mount arm and is configured to position an optical member relative to the user's eye when the mount arm is mounted to the helmet. When the mount arm is mounted to the helmet, the mount arm is configured to pivot from an in-use position where the optical member is positioned in front of the user's eye to a stowage position where the optical member is moved out of the user's field of vision.

### CROSS-REFERENCE TO RELATED APPLICATIONS

This application claims the benefit of U.S. Provisional Patent Application No. 61/824,908 filed May 17, 2013 entitled “Mount Arm for A Helmet Mounted Display”, which is incorporated by reference herein in its entirety.

### BACKGROUND OF THE INVENTION

The present invention generally relates to mount arm for a helmet mounted display and, more particularly, to a mount arm that attaches a display, also referred to as a helmet mounted display or HMD, such as a targeting device used by infantry or pilots, to a helmet and allows the user to position the location of the display in front of the user's eye.

### BRIEF SUMMARY OF THE INVENTION

In one embodiment there is a device comprising a mount arm having a first end and a second end, the first end configured to be mounted to a helmet, the mount arm having a first adjustment mechanism proximate the first end and configured to position the second end of the mount arm relative to a user's eye when the mount arm is mounted to the helmet; and a second adjustment mechanism proximate the second end of the mount arm and configured to position an optical member relative to the user's eye when the mount arm is mounted to the helmet, wherein when the mount arm is mounted to the helmet the mount arm is configured to pivot from an in-use position where the optical member is positioned in front of the user's eye to a stowage position where the optical member is moved out of the user's field of vision.

In one embodiment, the mount arm includes a front arm and a rear arm, the rear arm being coupled to the front arm by a joint, the joint releasably retaining the front arm and rear arm relative to one another in a first position and a second position, wherein when the mount arm is in the in-use position the front arm and the rear arm are in the first position and when the mount arm is in the stowage position the front arm and the rear arm are in the second position.

In one embodiment, the rear arm includes a lock configured to releaseably retain the rear arm in the in-use position. In one embodiment, the lock includes a pull lever having at least one cammed surface configured to lock and release the rear arm relative to a housing mounted to the helmet. In one embodiment, the front arm is curved. In one embodiment, the rear arm is generally straight. In one embodiment, when mounted to the helmet, the rear arm is configured to pivot relative to the helmet about a first axis and the front arm configured to pivot relative to the rear arm at the joint about a second axis, the first axis being generally perpendicular to the second axis. In one embodiment, the joint includes a ball plunger hinge. In one embodiment, the front arm and the rear arm are comprised of a substantially rigid material.

In a further embodiment, the device includes a mounting bracket configured to attach to the helmet. In one embodiment, the first end of the mount arm is configured to be removably mounted to the mounting bracket. In one embodiment, the mount arm is pivotable relative to the mounting bracket. In one embodiment, the position of the first and second adjustment mechanisms are maintained while moving the mount arm from the in-use position to the stowage position and back to the in-use position. In one embodiment, the first adjustment mechanism includes a worm gear. In one embodiment, the second adjustment mechanism includes a paddle coupled to a cammed plunger. In one embodiment, the mount arm includes a lock configured to releaseably retain the mount arm in the in-use position. In one embodiment, the device includes the optical member. In one embodiment, the optical member includes a frameless, transparent, display window. In one embodiment, the second adjustment member is coupled between the optical member and the second end of the mount arm.

### BRIEF DESCRIPTION OF THE SEVERAL VIEWS OF THE DRAWINGS

The foregoing summary, as well as the following detailed description of embodiments of the mount arm for a helmet mounted display, will be better understood when read in conjunction with the appended drawings of an exemplary embodiment. It should be understood, however, that the invention is not limited to the precise arrangements and instrumentalities shown.

In the drawings:

FIG. 1 is a perspective view of a mount arm for a helmet mounted display in accordance with an exemplary embodiment of the present invention shown mounted to a helmet in the in-use position;

FIG. 2 is a side view of the mount arm shown in FIG. 1;

FIG. 3 is a front view of the mount arm shown in FIG. 1;

FIG. 4 is a side view of the mount arm of FIG. 1 shown in the stowage position;

FIG. 5 is a perspective view of the mount arm of FIG. 1 illustrating how the mount arm attaches to the helmet;

FIG. 6 is a perspective view of a front arm of the mount arm shown in FIG. 1;

FIG. 7 is a rear perspective view of the front arm shown in FIG. 6;

FIG. 8 is a cross sectional view of the front arm and helmet mounted display of the mount arm shown in FIG. 6 taken along line 8-8;

FIG. 9 is a perspective view of a rear arm of the mount arm shown in FIG. 1;

FIG. 10A is a cross section of the rear arm of FIG. 9 taken along line 10-10 shown in the locked position; and

FIG. 10B is the cross section of the rear arm of FIG. 9 taken along line 10-10 shown in the released or moveable position.

### DETAILED DESCRIPTION OF THE INVENTION

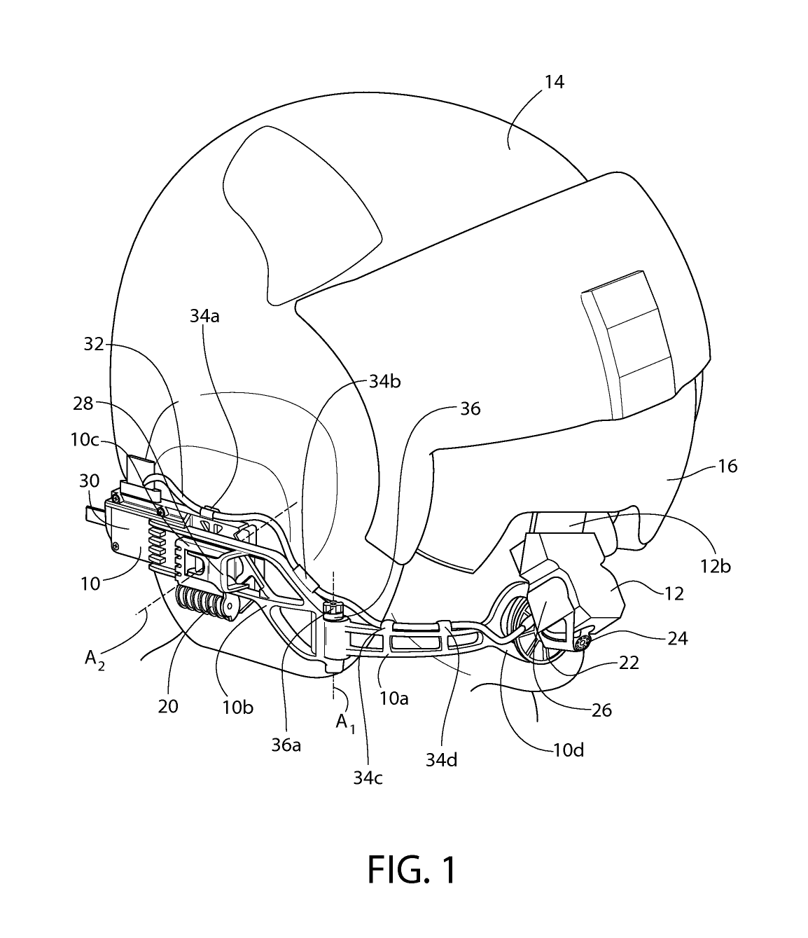

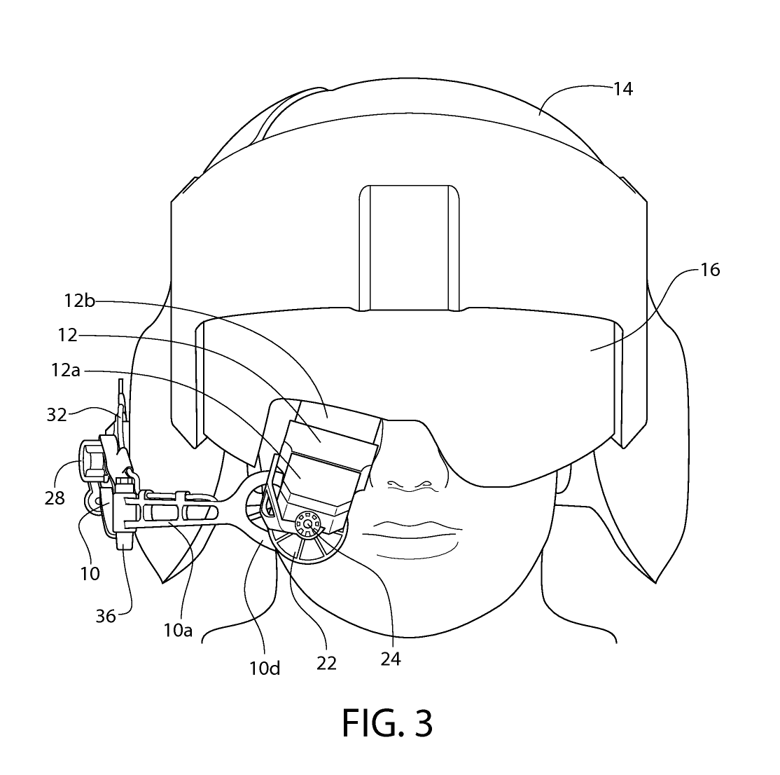

Referring to the drawings in detail, wherein like reference numerals indicate like elements throughout, there is shown in FIGS. 1-10B a mount arm, generally designated 10, in accordance with an exemplary embodiment of the present invention.

The mount arm 10 is a mounting device that attaches a display 12, also referred to as a helmet mounted display or HMD, such as a targeting device used by infantry or pilots, to a helmet 14 and allows the user to fine tune the location of the display 12 in front of and relative to the user's eye. The mount arm 10 is designed so that it can be adjusted to fit a wide variety of user preferences and anatomies. In addition, the mount arm 10, in some embodiments, may be positioned away from the eye of the user and stowed safely on the top of the helmet when not in use while retaining the positioning adjustments. Further, the mount arm 10, in some embodiments, may be detached from the helmet 14 in a storage position and reattached to the helmet 14 while retaining the positioning adjustments.

Previous mount arm devices were often heavy, obstructed the user's view and did not offer the positioning and repositioning of the display as the mount arm described herein.

The mount arm 10, among other advantages, may allow for a user to position a display in front of their eye while minimizing field of view interference caused by the mount arm 10 itself, provide a strong, stable and light support for the display 12, stow the display 12 while keeping it mounted to the helmet 14 so that the display 12 can be re-deployed quickly with one hand of the user, allow the user to fine tune the location of the display 12 to their preference, allow the user to pull away the display 12 from their eye to stow or wipe or clean the eye and then put the display 12 back over the eye without having to recalibrate the system (i.e., adjust the relative position of the components of the system relative to one another), removeably mount the mount arm 10 to the helmet 14 so the mount arm 10 can be taken off of the helmet 14 when not in use, manage the cabling for the display 12, and/or provide a strong support device for the display 12 without creating any source of magnetic interference.

Referring to FIGS. 1-3, the mount arm 10 may include an assembly of parts that work in concert to position the display 12 relative to the user's eye. One end of the mount arm 10 may be coupled to the helmet 14 and the other end may be coupled to the display 12. In one embodiment, the mount arm 10 and the display housing 12a are located below the user's eye to position the display window 12b between a visor lens 16 of the helmet 14 and the user's eye. In one embodiment of the present invention, a visor lens 16 is provided. The visor lens 16 may be partially cut away along the bottom edge of the visor lens 16 to make room for the display housing 12a and allow for the display window 12b to be positioned closer to the user's eye. The visor lens 16 may be at least partially retractable relative to the helmet 14 allowing the mount arm 10 to be pivoted away from the user's eye so that the display 12 clears the helmet 14 when pivoting the mount arm 10 into the stowage position on the top of the helmet 14 as discussed further below. In one embodiment of the present invention, a helmet 14 is provided. The helmet 14 may be an aircrew helmet such as the 56P Air Crewmen Helmet. The mount arm 10, display 12, visor 16 and helmet 14 may be provided as separate components or two or more components may be bundled together to create a kit or system.

The display 12 is an optical member that may display any desirable object in the user's field of vision such as instrument readings, maps, notifications, and targets. The display 12 may display one or more symbols, pictures or video to the user that include one or more colors. The display 12 may be configured as a heads-up display (HUD) that presents data to the user without requiring the user to look away from their usual viewpoints. The display window 12b may be a frameless, optically transparent panel. The display window 12b may be any shape including rectangular, oval or circular. The display window 12b may extend from the display housing 12a. The display housing 12a may surround and protect electronic components (not shown) that project an image across the display window 12b. In one embodiment, the display window 12b includes a plurality of prisms that reflect the projected image towards the user's eye. In one embodiment, the display window 12b is only supported by the display housing 12a along a bottom edge of the display window 12b.

In one embodiment, the display window 12b includes a transparent display such as a liquid crystal on silicon (LCOS) or liquid crystal display (LCD) along with an illuminated image such as using an LED illuminator to generate the displayed image. In one embodiment, the display window 12b projects forward looking infrared (FLIR) or night vision goggle (NVG) imagery. In one embodiment, the display 12 includes a Scorpion Targeting system.

The base housing 30 may include electronics, such as a video signal generating circuit board, that are coupled to the electronics in the display housing 12a. Providing at least some of the electronics in the base housing 30 rather than in the display housing 12a may allow for size and weight to be distributed closer to the first end 10c of the mount arm 10 rather than toward the second end 10d of the mount arm 10. In one embodiment, the electronics in the base housing 30 are hard wired or wirelessly coupled to additional electronic devices such as a data input and a power source.

In one embodiment, the electronics in the base housing 30 are electronically coupled to the electronics in the display housing 12a by one or more wires 32. The wire 32 may be mounted to the mount arm 10 by one or more clips 34a, 34b, 34c, 34d. In one embodiment, the clips 34a, 34b, 34c, 34d are integrally formed with the mount arm 10. In other embodiments, the clips 34a, 34b, 34c, 34d are separately attached to the mount arm 10. The wire 32 may be removelably attached to the mount arm 10 to allow for easy assembly and replacement of one or more of the electrical components. The wire 32 may be coupled to the mount arm 10 in a different manner such as extending through a hollow portion of the mount arm 10 or wrapped around portions of the mount arm 10. In other embodiments, the electronics in base housing 30 are wirelessly coupled to the electronics in the display housing 12a.

The mount arm 10 may be adjustable in order to lockably position the display 12 relative to the user's eye. Though a display 12 for a single eye is shown, a display for both eyes may be used. In one embodiment, the adjusted position of the display 12 is maintained throughout stowing, deploying and removal of the mount arm such that the display 12 is in the desired position upon subsequent re-deployments of the display 12.

Referring to FIGS. 1-3, the mount arm 10 has a first end 10c and a second end 10d. The first end 10c is configured to be mounted to the helmet 14 and the second end 10d is configured to be mounted to the display 12. In one embodiment, the mount arm 10 is mounted to one side of the helmet 14. In other embodiments, two mount arms 10 are provided, one on each side of the helmet 14.

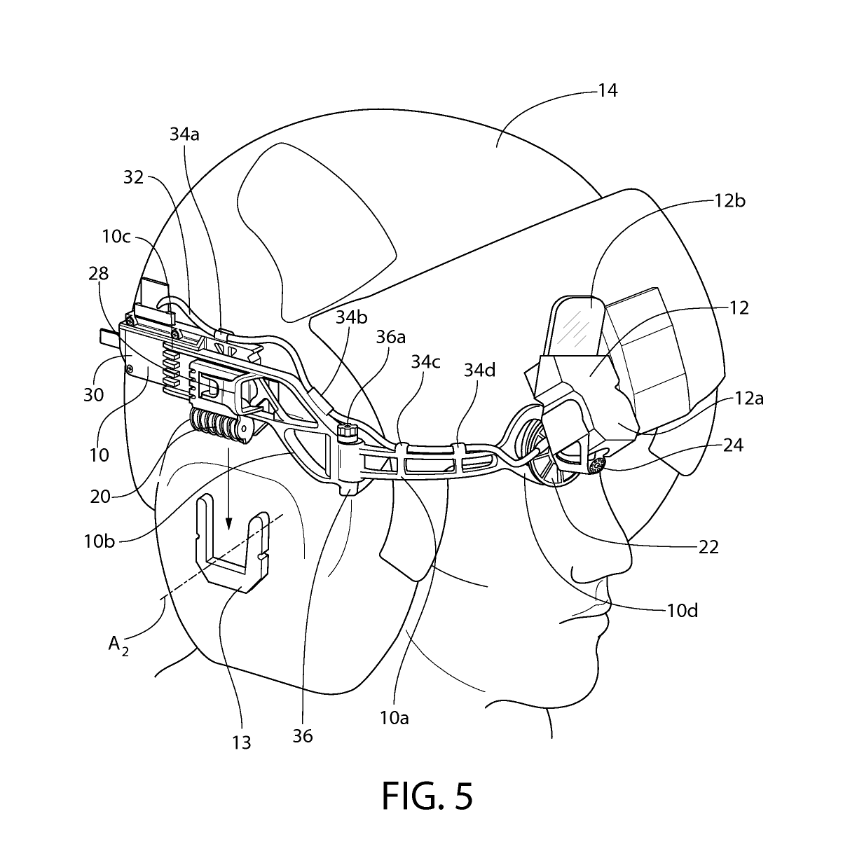

Referring to FIG. 5, the mount arm 10 may be removeably mounted to the helmet 14 to remove the mount arm 10 in a storage position. In one embodiment, the mount arm 10 is mounted to the helmet 14 by a mounting bracket 13. The mount arm 10 may be snap fit into the mounting bracket 13. In other embodiments, the bracket 13 includes a lock that retains the mount arm 10 in place and a release mechanism must be actuated in order to remove the mount arm 10 from the bracket 13. In one embodiment, the mounting bracket 13 is a U-shaped bayonet bracket that is configured to receive and release the base housing 30 or second end 10c of the mount arm 10. In other embodiments, the mounting bracket 13 is a mounting rail, such as disclosed in U.S. Pat. No. 7,849,517, which is incorporated by reference in its entirety, that allows for the mount arm 10 to be mounted to the helmet 14 in a plurality of positions. In one embodiment, the mounting bracket 13 is configured to mount to a mounting rail. In other embodiments, the mount arm 10 mounts directly to the mounting rail.

In one embodiment, the mounting bracket 13 is fixedly attached to the helmet 14 and the mount arm 10 is removeably coupled to the mounting bracket 13. The mounting bracket 13 may be attached to the helmet using one or more fasteners. In other embodiments the mounting bracket 13 is integral with the helmet 14 or attached to the helmet using an adhesive. The mounting bracket 13 may be oriented and configured so that the mount arm 10 is mounted by sliding the mount arm 10 in a downward direction as shown in FIG. 5. In other embodiments, the mount arm 10 is mounted by moving the mount arm 10 in a different direction such as forward, backward or from the side. In one embodiment, the mount arm 10 is mounted to the side of the helmet 14. In one embodiment, the mount arm 10 is mounted to the ear cup of the helmet 14. In one embodiment, the mount arm 10 is mounted to the helmet 14 proximate the ear of the user.

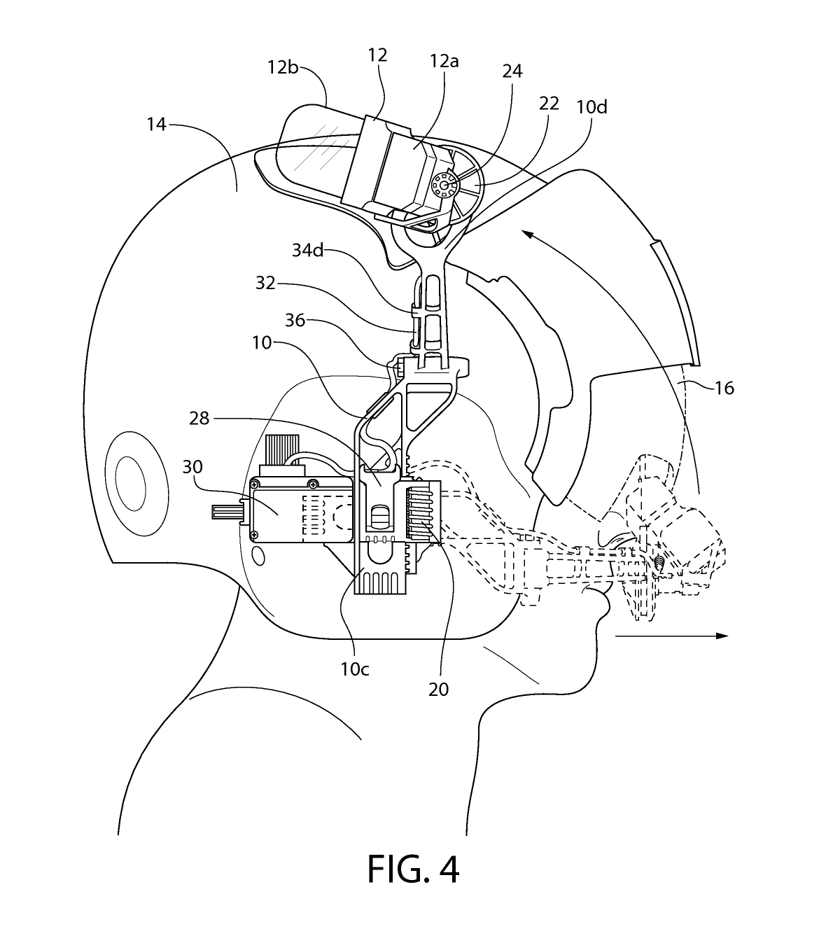

Referring to FIG. 4, when the mount arm 10 is mounted to the helmet 14 the mount arm 10 is configured to pivot from an in-use position where the display 12 is positioned in front of a user's eye to a stowage position where the display 12 is moved out of a user's field of vision. In one embodiment, the display 12 is proximate the top of the helmet 14 in the stowage position. In one embodiment, the mounting bracket 13 is pivotable relative to the helmet 14 about axis A₂ (see FIG. 5). In one embodiment, the mount arm 10 in the in-use position is generally perpendicular to the mount arm 10 in the stowage position.

Referring to FIGS. 1-3, the mount arm 10 may include two or more parts that are moveable relative to one another such that the mount arm 10 is adjustable to position the display 12 relative to the user's eye, but once adjusted, may lockably maintain the display 12 in a desired position during use. In one embodiment, the mount arm 10 includes a front arm 10a and a rear arm 10b. In one embodiment, the front arm 10a and the rear arm 10b are comprised of a substantially rigid material. In one embodiment, the front arm 10a and the rear arm 10b are comprised of metal such as aluminum or titanium. In one embodiment, the front arm 10a and the rear arm 10b are comprised of 6061 aluminum. In other embodiments, the front arm 10a and the rear arm 10b are comprised of plastic. The front arm 10a and the rear arm 10b may have a scaffold structure, such as a plurality of triangularly or rectangularly shaped members, that act reduce the weight and amount of material used for front arm 10a and the rear arm 10b while maintaining sufficient strength and stability for positioning and holding the display 12.

The mount arm 10 may be shaped to extend from the side of the helmet 14 across the cheek of the user and under an eye of the user. In one embodiment, the rear arm 10b is generally straight and the front arm 10a is curved. In other embodiments, the rear arm 10b and the front arm 10a are curved or the rear arm 10b is curved and the front arm 10a is straight.

The rear arm 10b may be coupled to the front arm 10a by a joint 36. The joint may be a moveable hinge that allows the mount arm 10 to be moved outboard (e.g., approximately 20 to approximately 30 degrees) to clear the visor 16 and the brim of the helmet 14 when the mount arm 10 is rotated to the stowage position (see FIG. 4). In one embodiment, the joint 36 is a ball plunger hinge. The force required to move the front arm 10a relative to the rear arm 10b may be adjustable. In one embodiment, the resistance of the joint 36 is adjustable by turning a knob 36a. In other embodiments, the joint 36 includes a lock to lockably retain the rear arm 10b relative to the front arm 10a. The joint 36 may be located proximate the midline of the mount arm 10. In one embodiment, the joint 36 is positioned proximate the edge of the helmet 14 when the mount arm 10 is mounted to the helmet 14. In other embodiments, the joint 36 is positioned closer to the first end 10c or second end 10d of the mount arm 10.

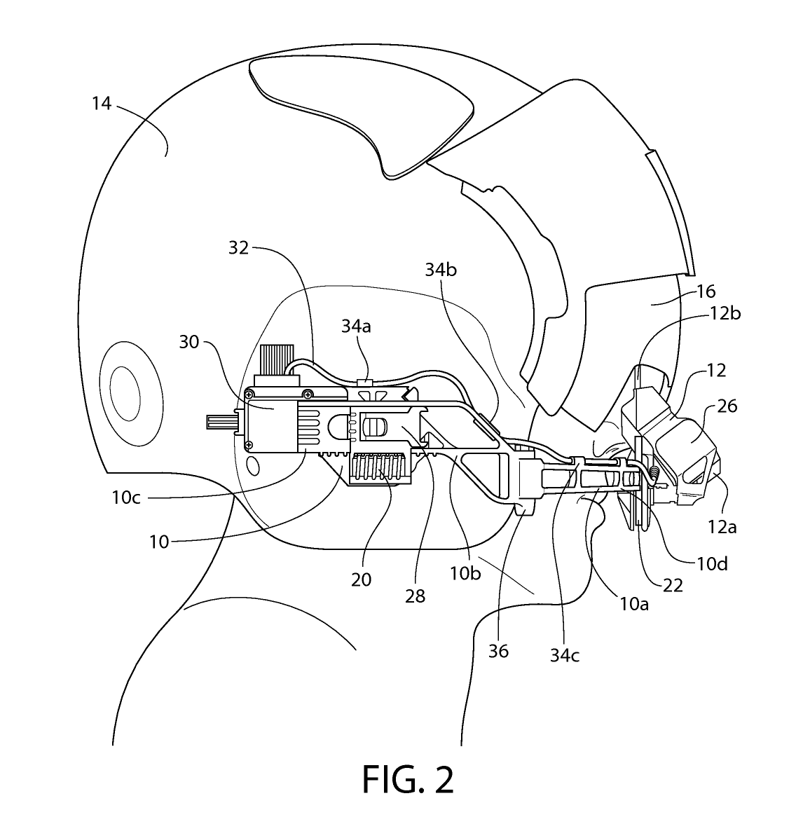

Referring to FIGS. 1, 2 and 9, the mount arm 10 may include a first adjustment mechanism 20 that is adjustable fore and aft to move the display 12 towards and away from the user's eye. In one embodiment, the first adjustment mechanism 20 is located proximate the first end 10c of the mount arm 10. In other embodiments, the first adjustment mechanism 20 is located along the mount arm 10 or proximate the display 12. The first adjustment mechanism 20 may couple the rear arm 10b with the base housing 30. Using the first adjustment mechanism 20, the user may slide the rear arm 10b relative to the base housing 30. The first adjustment mechanism 20 may be configured and positioned such that it is operable with one hand of the user when the mount 10 is mounted to the helmet 14. In one embodiment, the first adjustment mechanism 20 includes a worm gear. The worm gear may be coupled to a rack positioned on the bottom of the mount arm 10 (see FIG. 2) such that twisting the worm gear translates the mount arm 10.

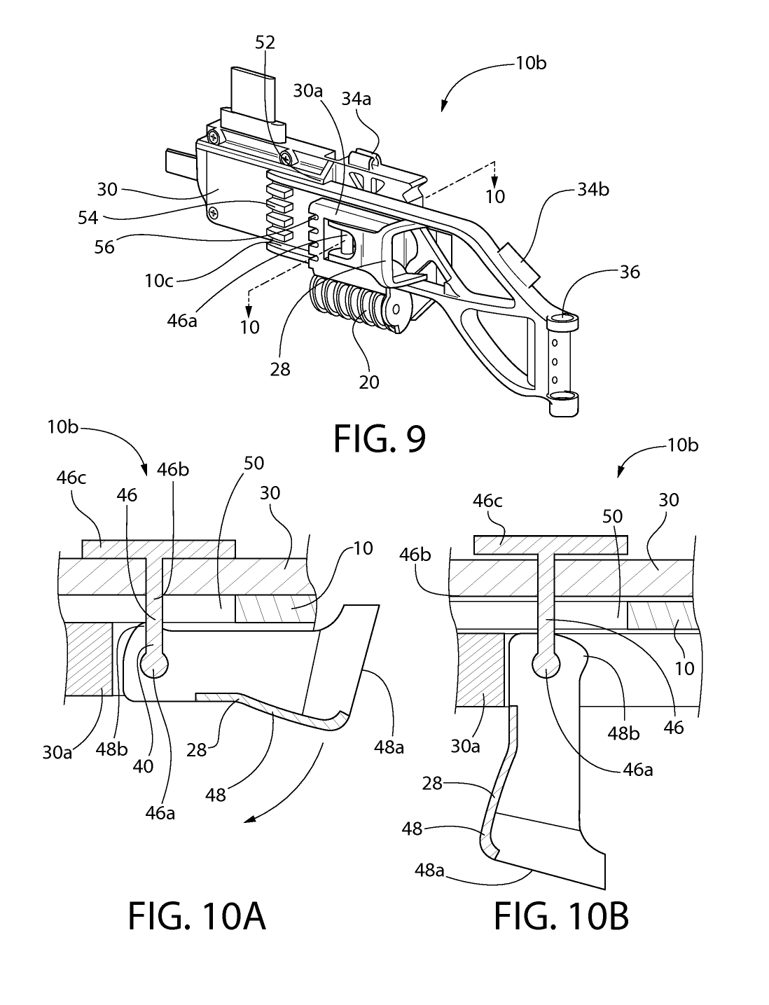

Referring to FIGS. 9-10B, the rear arm 10b includes a lock 28 configured to releaseably retain the rear arm 10b in the in-use position. The lock 28 may be positioned proximate the first end 10c of the mount arm 10. The lock 28 may sandwich the mount arm 10 between a lock housing 30a and the base housing 30. In one embodiment, the lock 28 releasably retains the mount arm 10 against or relative to the base housing 30. In the locked position (FIGS. 9 and 10A), the lock 28 is engaged and may retain the mount arm 10 relative to the base housing 30. In the released or moveable position (FIG. 10B), the lock 28 is released and the first adjustment mechanism 20 may be actuated to translate mount arm 10 forward and backward or the mount arm 10 may be pivoted relative to the base housing 30 and into the stowage position. Once the mount arm 10 is moved to the desired position, the lock 28 may be re-engaged to retain the mount arm 10 in the desired position relative to the base housing 30. The mount arm 10 may include a limit stop 54 configured to abut the lock housing 30a to prevent the first adjustment mechanism 20 from releasing the mount arm 10. In one embodiment, the limit stop 54 includes one or more projections 54. The lock housing 30a may include a plurality of corresponding grooves 56. In one embodiment, the grooves 56 are provided for weight reduction purposes.

The lock 28 may include a pull lever 48. The pull lever 48 may include an opening 48a that is configured to receive a user's index or middle finger when the user is holding the rear arm 10b with their hand. The pull lever 48 may be coupled to a lock arm 46. The lock arm 46 may include a pin 46a. The pull lever 48 may be rotatably coupled to the pin 46a. The pin 46a may be coupled to a cross member 46b that extends through a hole 50 in the mount arm 10 and through the base housing 30. The pin 46a may be generally perpendicular to the cross member 46b. The hole 50 may be sized and configured to allow the cross member 46 to rotate about axis A₂ (see FIG. 1) and translate on a plane generally perpendicular to axis A₂. The cross member 46b may be coupled to a back plate 46c that prevents the cross member 46b from being pulled through the base housing 30 when the lock 28 is actuated.

Referring to FIGS. 10A and 10B, the pull lever 48 may include a cammed surface 48b that is thicker between the pin 46a and the back plate 46c when the pull lever 48 is in the locked position (FIG. 10A) than when the pull lever 48 is in the released position (FIG. 10B). Due to the shape of the cammed surface 48b, the pull lever 48 controls how closely the mount arm 10 is held against base housing 30. Once the lock 28 is released by pulling and pivoting out the pull lever 48 from the locked position to the released position, the mount arm 10 may be moved about a plane generally perpendicular to axis A₂ (see FIG. 1) and rotated about axis A₂ (see FIG. 4). In other embodiments, the base housing 30 and the lock 28 are configured to allow the user to free handedly move the mount arm 10 on a plane generally perpendicular to axis A₂ and place the display in the desired position or close to the desired position relative to the helmet 14 in the moveable position and then lock the mount arm 10 in place.

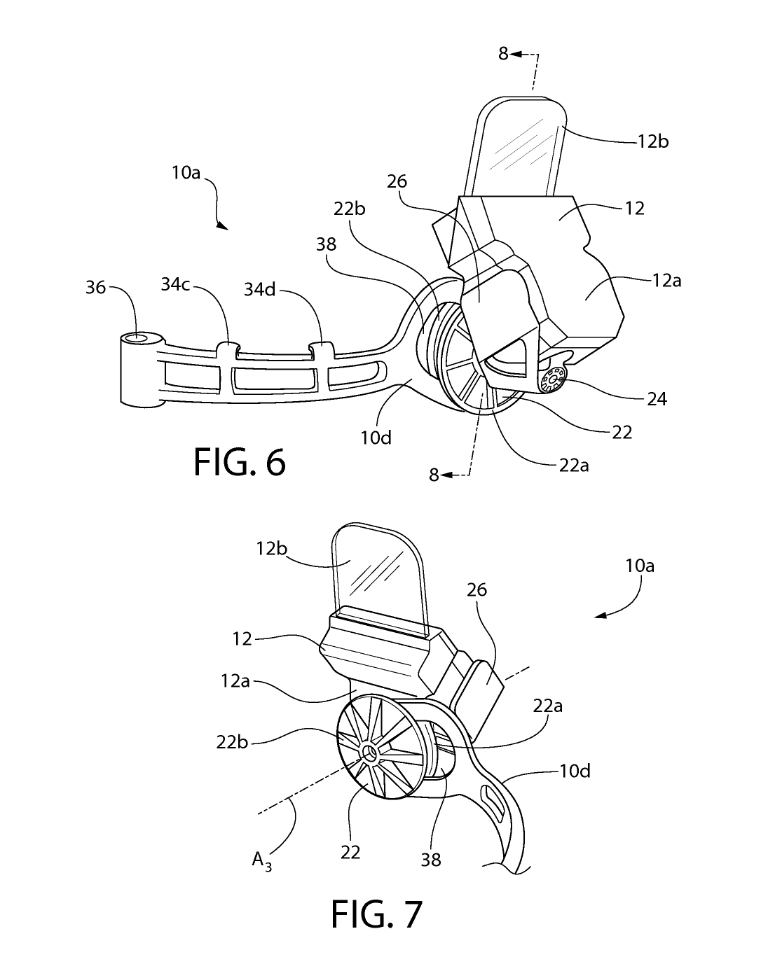

Referring to FIGS. 6-8, the mount arm 10 may include an additional adjustment mechanism(s) to rotate and/or allow for lateral and vertical adjustments of the display 12 relative to the user's eye. The mount arm 10 may include a second adjustment mechanism 22 to allow for lateral, vertical and rotational adjustment of the display 12 relative to the user's eye. In one embodiment, the second adjustment mechanism 22 allows for movement on a plane that is generally perpendicular to the plane on which the first adjustment mechanism 20 is moveable. In one embodiment, the second adjustment mechanism 22 is located proximate the display 12. In other embodiments, the second adjustment mechanism 22 is positioned at a different location along the mount arm 10 or proximate the first end 10c of the mount arm 10 or is combined with the first adjustment mechanism 20. In one embodiment, the second adjustment mechanism 22 is operable with a single hand of the user. In one embodiment, the second adjustment mechanism 22 is operable while the first adjustment mechanism 20 is in the locked position.

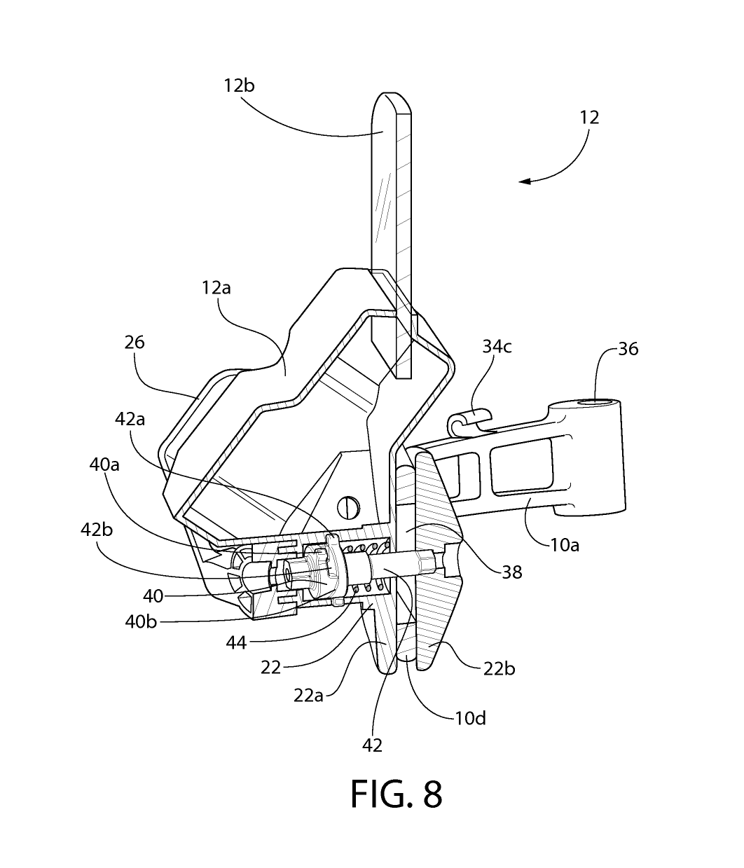

Referring to FIG. 8, the second adjustment mechanism 22 may include a paddle 26 coupled to a cammed plunger sub-assembly. In other embodiments, the second adjustment mechanism 22 includes one or more gimbles to allow for additional degrees of rotational freedom. In one embodiment, the second adjustment mechanism 22 allows for adjustment of the display 12 on a plane that is generally perpendicular to the plane that the first adjustment mechanism 22 is adjustable on. In one embodiment, the second adjustment mechanism 22 allows for three degrees of freedom adjustment (e.g., side-to-side, up and down, and rotation about axis A₃). In another embodiment, the second adjustment mechanism 22 allows for additional degrees of freedom adjustment (e.g., about an axis perpendicular to axis A₃).

The paddle 26 may include a boss 24 (see FIG. 6) that is coupled to a plunger 42 such that when the paddle 26 is actuated, the boss 24 rotates the plunger 42 about axis A₃. In one embodiment, the second adjustment mechanism 22 includes a first pad 22a and a second pad 22b that sandwich the second end 10d of the mount arm 10. The first pad 22a and the second pad 22b may be coupled together by the plunger 42 and biased together by a spring 44. In the locked position, the first pad 22a and the second pad 22b may press on opposing sides of the second end 10d of the mount arm 10 to lock the display 12 in position relative to the second end 10d of the display arm 10. The second end 10d of the mount arm 10 may include an aperture 38 that the plunger 42 extends through and allows the plunger 42 to be rotated and translated when the first pad 22a and the second pad 22b are released from the second end 10b of the mount arm 10.

The second adjustment mechanism 22 may include one or more paddles 26 that are coupled to a first cammed collar 40 that rotates about the plunger 42 when the one or more paddles 26 are depressed or rotated. The first cammed collar 40 may include one or more projections 40a that extend into corresponding grooves that are stationary relative to the display 12. The grooves for the projections 40a may extend circumferentially such that the first cammed collar 40 may rotate but not translate along the axis of the plunger 42. The second cammed collar of the plunger 42 may include one or more projections 42a that extend into corresponding grooves that are stationary relative to the display 12. The grooves for the projections 42a may extend longitudinally along the axis of the plunger 42 such that the plunger may translate along its axis A₃ but does not rotate. The first cammed collar 40 may include a cammed surface 40b that is coupled to a cammed surface 42b of a second cammed collar of the plunger 42. When the first cammed collar 40 rotates, the cammed surface 40b rotates against the cammed surface 42b to translate the plunger 42 and expand the distance between first pad 22a and the second pad 22b to free the second adjustment mechanism 22 from the front arm assembly 10a and move the display 12 to the desired position relative to the user's eye. Releasing the paddle 26 allows the spring 44 to expand translating the plunger 42, rotating the first cammed collar 40 and the paddle 26 and locking the display 12 in place relative to the mount arm 10.

To operate the second adjustment mechanism 22, the user may squeeze the paddle 26 toward the display housing 12a between a thumb and one or more fingers of a single hand to release the second adjustment mechanism 22. The second adjustment mechanism 22 may lock the display 12 relative to the second end 10d of the mount arm 10 upon release of the paddle 26. In one embodiment, by locking the display 12 in place upon release of the paddle 26 rather than by application of a force, such as depressing a lever or twisting a knob, the display 12 is more likely to remain in the intended position. Requiring application of a force to lock the second adjustment mechanism 22 may move or shift the display 12 from the intended position.

Referring to FIG. 4, the mount arm 10 may be pivotable proximate the helmet 14 to pivot the display 12 relative to the helmet 14. In one embodiment, the rear arm 10b is rotated relative to the base housing 30. The mount arm 10 may pivot the display 12 vertically up and down about axis A₂ (see FIG. 1) and can be locked into position. The mount arm 10 may swing the display up onto the top of the helmet 14 in a stowage position. The mount arm 10 may include a lock 28 that a user must first release in order to pivot the mount arm 10 relative to the helmet 14. In other embodiments, the mount arm 10 snap fits into place or is held in the in-use or storage positions via a cam. The base housing 30 may include a limit stop 52 (see FIG. 9) that contacts the top surface of the mount arm 10 in the in-use and stowage positions to prevent the mount arm 10 from rotating further than horizontal at 0° and vertical at 90°.

Referring to FIG. 5, the invention may include a method of mounting and/or positioning the mount arm 10. In one exemplary embodiment, a mounting bracket 13 is secured to a side of the helmet 14. The base housing 30 proximate a first end 10c of the mount arm 10 is then coupled to the mounting bracket 13. After mounting the mount arm 10 to the helmet 14, the front arm 10a is pivoted about axis A₁ (see FIG. 1) into the first position relative to the rear arm 10b (e.g., closer to the user's face).

Referring to FIGS. 1-3, the user may then use the first and second adjustment mechanisms 20, 22 to adjust the position of the display 12 relative to the user's eye. In one embodiment, the user first uses the first adjustment mechanism 20 to position the display the desired distance from the user's eye before using the second adjustment mechanism 22 to position the display in the desired horizontal, vertical and rotational position relative to the user's eye. In other embodiments, the user may actuate the second adjustment mechanism 22 before actuating the first adjustment mechanism 20 or the user may use an iterative approach switching between the first and second adjustment mechanisms 20, 22 to set the display 12 in the desired position relative to their eye. In other embodiments, where the first adjustment mechanism 20 allows for free hand adjustment, the user releases the pull lever 48 (FIG. 10B), grasps the rear arm 10b with their hand, moves the mount arm 10 along a plane generally perpendicular to axis A₂ (see FIG. 1) to the desired position, and then closes the pull lever 48 (FIG. 10A). In some embodiments, the user may then use the display 12 or further adjust the position of the display 12 relative to their eye using the first and/or second adjustment mechanisms 20, 22.

The first and/or second adjustment mechanism 20, 22 may be used to fine tune the position of the display 12 relative to the user's eye. For fine tune adjustment of the display 12 toward and away from the user's eye, the user may twist the worm gear of the first adjustment mechanism 20. For adjustment of the display on an a plane generally perpendicular to the plane on which the first adjustment mechanism moves the mount arm, the user may squeeze the paddle 26 toward the display housing 12a, position the display, and then release the paddle 26. Once the display 12 is positioned relative to the user's eye, the user may deploy the visor 16 from the helmet 14 over their eyes such that the display 12 is between the user's eye and the visor 16.

Referring to FIG. 4, to stow the mount arm 14, the user may retract the visor 16 and then pivot the front arm 10a relative to the rear arm 10b about axis A₁ (see FIG. 1) away from the user's face and into the second position. The user may then release the lock 28 by pulling the pull lever 48 (see FIGS. 10A and 10B) and pivot the mount arm 10 relative to base housing 30 about axis A₂ (see FIG. 1) until the display is on the top of the helmet 14. Once the mount arm 14 is in the stowage position, the user may push the pull lever 48 back toward the mount arm 10 to lock the mount arm 10 in place relative to the helmet 14. In one embodiment, the first axis A₂ is generally perpendicular to axis A₁. In one embodiment, the mount arm 10 in the in-use position is generally perpendicular to the mount arm 10 in the stowage position. In other embodiments, the mount arm 10 in the in-use position is at an acute angle or obtuse relative to the mount arm 10 in the stowage position.

In one embodiment, the position of the first and second adjustment mechanisms 20, 22 are maintained while moving the mount arm 10 from the in-use position to the stowage or storage positions and back to the in-use position. Maintaining the settings of the first and second adjustment mechanisms 20, 22 when moving the mount arm between the stowage and in-use positions and the mounted and storage positions may save time as the position of the display 12 relative to the eye may be set and then re-deployed ready to be used.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

I/we claim:

1. A device comprising:
a mount arm having a first end and a second end, the first end configured to be mounted to a helmet, the mount arm having a first adjustment mechanism proximate the first end and configured to position the second end of the mount arm relative to a user's eye when the mount arm is mounted to the helmet; and
a second adjustment mechanism proximate the second end of the mount arm and configured to position an optical member relative to the user's eye when the mount arm is mounted to the helmet,
wherein when the mount arm is mounted to the helmet the mount arm is configured to pivot from an in-use position where the optical member is positioned in front of the user's eye to a stowage position where the optical member is moved out of the user's field of vision.

2. The device of claim 1, wherein the mount arm includes a front arm and a rear arm, the rear arm being coupled to the front arm by a joint, the joint releasably retaining the front arm and rear arm relative to one another in a first position and a second position, wherein when the mount arm is in the in-use position the front arm and the rear arm are in the first position and when the mount arm is in the stowage position the front arm and the rear arm are in the second position.

3. The device of claim 2, wherein the rear arm includes a lock configured to releaseably retain the rear arm in the in-use position.

4. The device of claim 3, wherein the lock includes a pull lever having at least one cammed surface configured to lock and release the rear arm relative to a housing mounted to the helmet.

5. The device of claim 2, wherein the front arm is curved.

6. The device of claim 5, wherein the rear arm is generally straight.

7. The device of claim 2, wherein when mounted to the helmet the rear arm is configured to pivot relative to the helmet about a first axis and the front arm configured to pivot relative to the rear arm at the joint about a second axis, the first axis being generally perpendicular to the second axis.

8. The device of claim 2, wherein the joint includes a ball plunger hinge.

9. The device of claim 2, wherein the front arm and the rear arm are comprised of a substantially rigid material.

10. The device of claim 1 further comprising:
a mounting bracket configured to attach to the helmet.

11. The device of claim 10, wherein the first end of the mount arm is configured to be removably mounted to the mounting bracket.

12. The device of claim 10, wherein the mount arm is pivotable relative to the mounting bracket.

13. The device of claim 1 further comprising:
the optical member coupled to the second end of the mount arm.

14. The device of claim 13, wherein the optical member includes a frameless, transparent, display window.

15. The device of claim 13, wherein the second adjustment member is coupled between the optical member and the second end of the mount arm.

16. The device of claim 1, wherein the position of the first and second adjustment mechanisms are maintained while moving the mount arm from the in-use position to the stowage position and back to the in-use position.

17. The device of claim 1, wherein the first adjustment mechanism includes a worm gear.

18. The device of claim 1, wherein the second adjustment mechanism includes a paddle coupled to a cammed plunger.

19. The device of claim 1, wherein the mount arm includes a lock configured to releaseably retain the mount arm in the in-use position.
